(19) United States
(12) Patent Application Publication
(10) Pub. No.: US 2021/0350149 A1
(43) Pub. Date: Nov. 11, 2021

(54) LANE DETECTION METHOD AND APPARATUS,LANE DETECTION DEVICE,AND MOVABLE PLATFORM

(71) Applicant: SZ DJI TECHNOLOGY CO., LTD., Shenzhen (CN)

(72) Inventors: Honghao LU, Shenzhen (CN); Xiongbin RAO, Shenzhen (CN); Peitao CHEN, Shenzhen (CN)

(21) Appl. No.: 17/371,270

(22) Filed: Jul. 9, 2021

Related U.S. Application Data
(63) Continuation of application No. PCT/CN2019/071658, filed on Jan. 14, 2019.

(51) Int. Cl. G06K 9/00; G06K 9/62; H04N 1/60; G06K 9/46; G01S 13/86; B60W 40/02

(52) U.S. Cl. CPC G06K 9/00798; G06K 9/6289; H04N 1/6016; G06K 9/4604; G06K 9/6218; B60W 60/001; G01S 13/867; B60W 40/02; B60W 2552/53; B60W 2420/52; G06K 9/6201

(57) ABSTRACT

A lane detection method includes obtaining visual detection data via a vision sensor disposed at a movable platform, performing lane line analysis and processing based on the visual detection data to obtain lane line parameters, obtaining radar detection data via a radar sensor disposed at the movable platform, performing boundary line analysis and processing based on the radar detection data to obtain boundary line parameters, and performing data fusion according to the lane line parameters and the boundary line parameters to obtain lane detection parameters.

### CROSS-REFERENCE TO RELATED APPLICATION

This application is a continuation of International Application No. PCT/CN2019/071658, filed Jan. 14, 2019, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of control technology and, in particular, to a lane detection method and apparatus, a lane detection device, and a movable platform.

### BACKGROUND

With the in-depth development of the unmanned driving industry, assisted driving and autonomous driving have become current research hotspots. In the field of assisted driving and autonomous driving, the detection and recognition of lanes are critical to the realization of unmanned driving.

The current lane detection method is mainly to capture an environmental image through a vision sensor, recognize the environmental image using an image processing technology, and realize a detection of the lane. However, the vision sensor is greatly affected by the environment. In scenarios of insufficient light, or rain or snow, the image captured by the vision sensor is not effective, which will significantly reduce the lane detection effect of the vision sensor. The current lane detection method cannot meet the lane detection needs in some special situations.

### SUMMARY

In accordance with the disclosure, there is provided a lane detection method including obtaining visual detection data via a vision sensor disposed at a movable platform, performing lane line analysis and processing based on the visual detection data to obtain lane line parameters, obtaining radar detection data via a radar sensor disposed at the movable platform, performing boundary line analysis and processing based on the radar detection data to obtain boundary line parameters, and performing data fusion according to the lane line parameters and the boundary line parameters to obtain lane detection parameters.

In accordance with the disclosure, there is provided a first interface, a second interface, a processor, and a memory. One end of the first interface is configured to be connected to an vision sensor. One end of the second interface is configured to be connected to a radar sensor. The processor is connected to another end of the first interface and another end of the second interface. The memory stores a program code that, when executed by the processor, causes the processor to obtain visual detection data via a vision sensor disposed at a movable platform, perform lane line analysis and processing based on the visual detection data to obtain lane line parameters, obtain radar detection data via a radar sensor disposed at the movable platform, perform boundary line analysis and processing based on the radar detection data to obtain boundary line parameters, and perform data fusion according to the lane line parameters and the boundary line parameters to obtain lane detection parameters.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic block diagram of a lane detection system according to an embodiment of the disclosure.

FIG. 2 is a schematic flowchart of a lane detection method according to an embodiment of the disclosure.

FIG. 3A is a schematic diagram showing determination of a lower rectangular image according to an embodiment of the disclosure.

FIG. 3B is a schematic diagram showing a grayscale image obtained based on the lower rectangular image shown in FIG. 3A according to an embodiment of the disclosure.

FIG. 3C is a schematic diagram showing a discrete image obtained based on the grayscale image shown in FIG. 3B according to an embodiment of the disclosure.

FIG. 3D is a schematic diagram showing a denoised image obtained based on the discrete image shown in FIG. 3C according to an embodiment of the disclosure.

FIG. 4 is a schematic diagram showing a vehicle body coordinate system of a movable platform according to an embodiment of the disclosure.

FIG. 5 is a schematic flowchart of a data fusion method according to an embodiment of the disclosure.

FIG. 6 is another schematic flowchart of a lane detection method according to an embodiment of the disclosure.

FIG. 7 is a schematic block diagram of a lane detection apparatus according to an embodiment of the disclosure.

FIG. 8 is a schematic block diagram of a lane detection device according to an embodiment of the disclosure.

### DETAILED DESCRIPTION OF THE EMBODIMENTS

A movable platform such as an unmanned car can perform lane detection based on a video image captured by a vision sensor and an image detection and processing technology, and determine a position of a lane line from the captured video image. The movable platform can first determine a lower rectangular area of the image from the video image captured by the vision sensor, convert the lower rectangular area into a grayscale image, perform a quadratic curve detection based on a Hough transform after the grayscale image is binarized and denoised, and recognize the lane line at a close distance. When the vision sensor is used to detect the lane line at a long distance, because of a poor resolution of the long-distance objects in the video images captured by the vision sensor, the vision sensor cannot capture the long-distance video images, and thus cannot effectively recognize the lane line at the long distance.

A radar sensor can emit electromagnetic wave signals and receive feedback electromagnetic wave signals. After the radar sensor emits the electromagnetic wave signals, if the electromagnetic wave signals hit obstacles, such as fences on both sides of the road or cars, they will be reflected, so that the radar sensor receives the feedback electromagnetic wave signals. After the radar sensor receives the feedback signals, the movable platform can determine signal points belonging to the boundary fences of the road based on speeds of the feedback signals received by the radar sensor, so that a clustering computation can be performed to determine the signal points belonging to each side and analyze the road boundary.

The method that the movable platform performs road boundary fitting based on the feedback electromagnetic signal received by the radar sensor to determine the road boundary line is not only suitable for a short-distance road boundary fitting, but also for a long-distance road boundary fitting. Therefore, The embodiments of the present disclosure provide a detection method of combining a radar sensor (such as millimeter wave radar) and a vision sensor, which can effectively utilize the advantages of the vision sensor and the radar sensor during detection, thereby obtaining a lane detection result with a higher precision and effectively meeting the lane detection needs in some special scenarios (such as a scenario with interference from rain or snow to the vision sensor). As a result, performance and stability of lane detection in the assisted driving system are improved.

The lane detection method provided in the embodiments of the present disclosure can be applied to a lane detection system shown in FIG. 1. The system includes a vision sensor 10, a radar sensor 11, and a data fusion circuit 12. The vision sensor 10 collects environmental images so that the movable platform can perform the lane detection based on the environmental images to obtain visual detection data. The radar sensor 11 collects point group data so that the movable platform can perform the lane detection based on the point group data to obtain radar detection data. After obtaining the visual detection data and the radar detection data, the data fusion circuit 12 performs data fusion to obtain a final lane detection result. The lane detection result can be directly output or fed back to the vision sensor 10 and/or the radar sensor 11. The data fed back to the vision sensor 10 and the radar sensor 11 can be used as a basis for a correction of a next lane detection result.

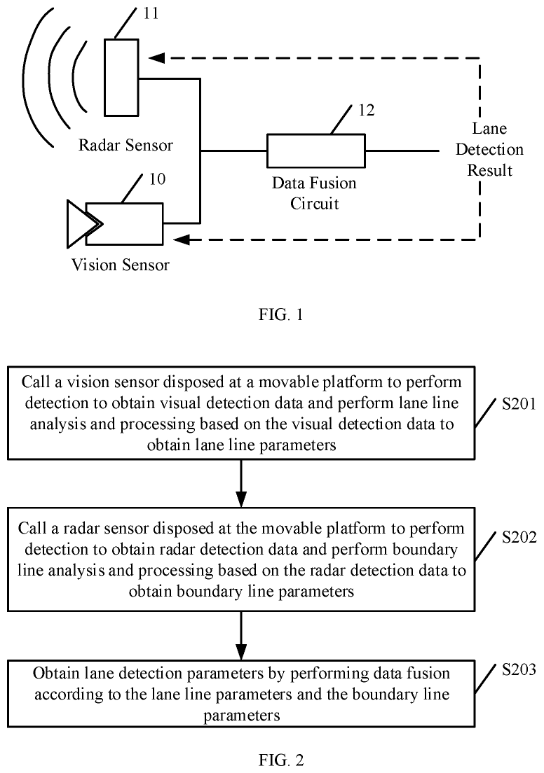

FIG. 2 is a schematic flowchart of a lane detection method according to an embodiment of the disclosure. The lane detection method can be executed by a movable platform, in some embodiments, by a processor of the movable platform. The movable platform includes an unmanned car (unmanned vehicle). As shown in FIG. 2, at S201, a vision sensor disposed at the movable platform is called to perform detection to obtain visual detection data, and perform lane line analysis and processing based on the visual detection data to obtain lane line parameters.

Since the ground on two sides of the lane is generally painted with lane lines with a large difference in color from the road, the vision sensor can collect the environment image in front of the movable platform (such as an unmanned vehicle), so that the movable platform can determine a position of the lane line from the collected environmental image based on the environmental image in front collected by the vision sensor and image processing technology to obtain the visual detection data.

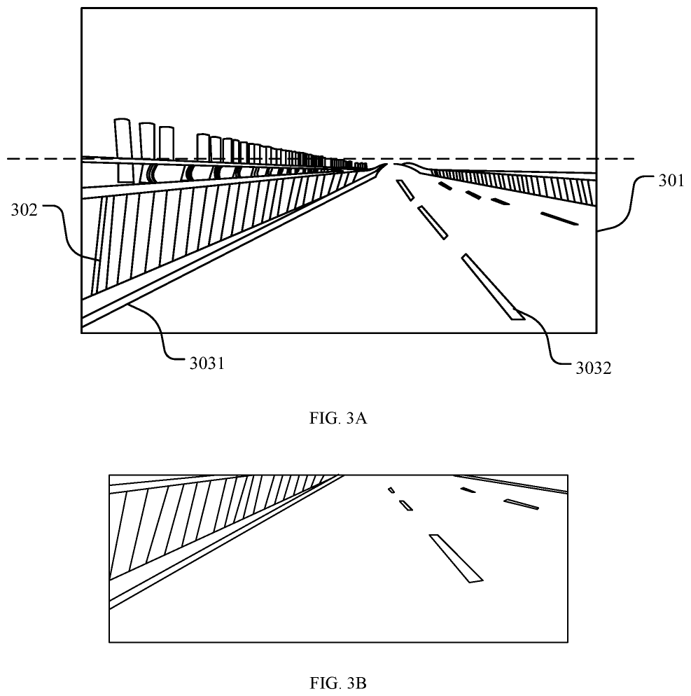

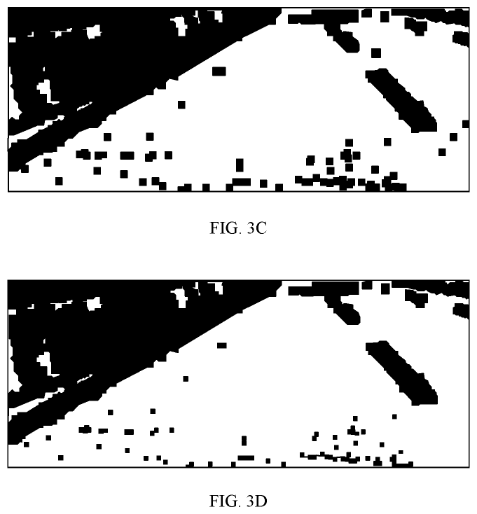

When the movable platform calls the vision sensor for lane detection, the vision sensor can be called to capture a video frame as an image. In some embodiments, the video frame captured by the vision sensor may be as shown in FIG. 3A. After the video frame image is obtained, an effective recognition area in the video frame image can be determined, that is, a lower rectangular area of the image is determined. The obtained lower rectangular area of the image is an area 301 identified below a dashed line in FIG. 3A. The lower rectangle of the image is an area where the road is located. The area where the road is located includes positions of the lane lines, such as positions marked by 3031 and 3032 as shown in FIG. 3A. The movable platform can perform image recognition based on semantic information of the lane line or image features to determine a lane line curve, which is used as a reference for assisted driving of movable platforms such as a unmanned car. Further, the area where the road is located also includes boundary obstacles such as fences indicated by 302 in the figure. The movable platform can detect the boundary obstacles 302 such as fences based on the feedback electromagnetic wave signals received by the radar sensor to determine a lane boundary curve.

In some embodiments, a correction to the lane line curve and the lane boundary curve determined based on the current frame can be realized according to the parameters of the lane boundary curve and the parameters of the lane line curve obtained last time, that is, the parameters of the lane boundary curve and the parameters of the lane line curve obtained according to the last frame of video frame image.

In order to analyze the effective recognition area, the obtained rectangular area in the lower part of the image marked by area 301 in FIG. 3A can be converted into a grayscale image. It is assumed that the converted grayscale image is as shown in FIG. 3B. After the grayscale image is obtained, an adaptive threshold can be used to binarize the grayscale image to obtain a discrete image for the grayscale image. The discrete image for the grayscale image shown in FIG. 3B is shown in FIG. 3C. Further, the discrete image is filtered to remove the noise of the discrete image, and the discrete image after denoising is shown in FIG. 3D.

In some embodiments, high-frequency noise points and low-frequency noise points can be removed based on a Fourier transform, and invalid points in the discrete image can be removed based on the filter. The invalid points refer to unclear points in the discrete image or noise points in the discrete image.

After a denoised discrete image shown in FIG. 3D is obtained, a quadratic curve detection can be performed based on a Hough transform to identify a position of the lane in the denoised image (that is, the lane line). In some embodiments, discrete points at the position of the lane in the denoised image can be used as visual detection data obtained by the vision sensor after the lane detection, so that a lane line analysis and processing can be performed based on the visual detection data to obtain the lane line curve and a corresponding first reliability. Therefore, the lane line parameters obtained after lane line analysis and processing based on the visual detection data include a first parameter of the lane line curve obtained by fitting discrete points located at the lane line position in the denoised image and the first reliability. The first parameter is also referred to as “first fitting parameter.” The lane line curve can be represented by a quadratic curve x₁=a₁y²+b₁y+c₁, and the first reliability can be represented by p1. Therefore, the lane line parameters obtained by analyzing and processing the lane line based on the visual detection data include a₁, b₁, c₁ and p1.

In some embodiments, the first reliability is determined based on the lane line curve and a distribution of discrete points used to determine the curve. When the discrete points are distributed near the lane line curve, the first reliability is high, and a corresponding first reliability value is relatively large. When the discrete points are scattered around the lane line curve, the first reliability is low, and the corresponding first reliability value is small.

In some other embodiments, the first reliability may also be determined based on a lane line curve obtained from a last captured video image frame and a lane line curve obtained from a current captured video image frame. Because a time interval between the last frame and the current frame is short, a position difference between the lane line curves determined by the last video image frame and the current video image frame is too large. If the difference between the lane line curves determined by the last video image frame and the current video image frame is too large, the first reliability is low, and the corresponding first reliability value is also small.

At S202, a radar sensor disposed at the movable platform is called to perform detection to obtain radar detection data, and boundary line analysis and processing are performed based on the radar detection data to obtain boundary line parameters.

The radar sensor can detect electromagnetic wave reflection points of obstacles near the movable platform by emitting electromagnetic waves and receiving feedback electromagnetic waves. The movable platform can use the feedback electromagnetic waves received by the radar sensor and use data processing methods such as clustering and fitting, etc. to determine the boundary lines located at both sides of the movable platform. The boundary lines correspond to metal fences or walls at the outside of the lane line. The radar sensor may be, for example, a millimeter wave radar.

When the movable platform calls the radar sensor for lane detection, returned electromagnetic wave signals received by the radar sensor are obtained as an original target point group, stationary points are filtered out from the original target point group, and a clustering calculation is performed based on the stationary points to filter out effective boundary point groups corresponding to the two boundaries of the lane. Further, a polynomial can be used to perform boundary fitting to obtain a boundary curve with a second parameter and a corresponding second reliability. The second parameter is also referred to as “second fitting parameter.” In some embodiments, a quadratic curve x₂=a₂y²+b₂y+c₂ may be used to represent the boundary curve, and p2 may be used to represent the second reliability. That is, the boundary line parameters can include a₂, b₂, c₂ and p2.

In some embodiments, the radar sensor can filter out stationary points based on a moving speed of each target point of the target point group, and perform clustering calculations based on distances before various points in the target point group to filter out the effective boundary point groups corresponding to the two boundaries of the lane respectively.

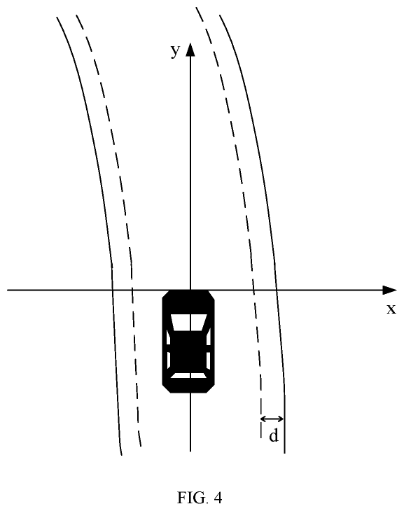

When the movable platform obtains the lane line curve based on the visual detection data fitting and obtains the boundary curve based on the radar detection data fitting, both are performed under a coordinate system corresponding to the movable platform. A vehicle body coordinate system of the movable platform is shown in FIG. 4. The lane line curve obtained by fitting is represented by a dashed curve in the figure, and the boundary curve obtained by fitting is represented by a solid curve in the figure.

At S203, lane detection parameters are obtained by performing data fusion according to the lane line parameters and the boundary line parameters.

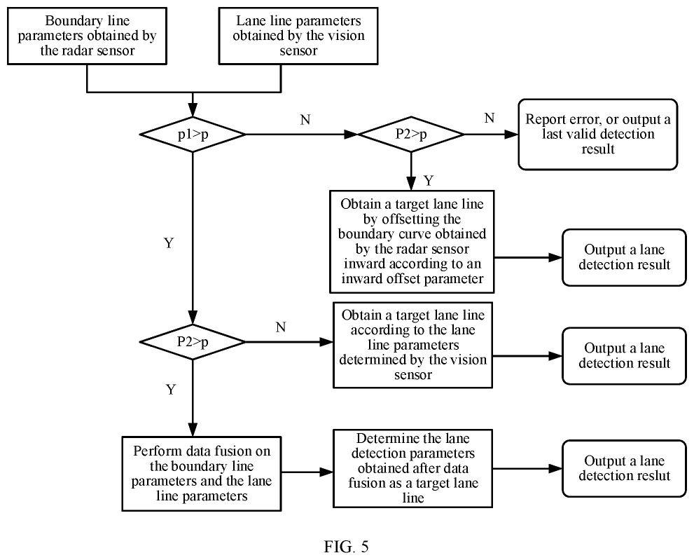

When the data fusion is performed based on the lane line parameter and the boundary line parameter, the first reliability p1 included in the lane line parameter and the second reliability p2 included in the boundary line parameter may be compared with a preset reliability threshold p. Based on different comparison results, the corresponding lane detection result is determined. As shown in FIG. 5, if p1>p and p2<p, it means that a reliability of the first parameter included in the lane line parameter is high, and a reliability of the second parameter included in the boundary line parameter is low. Therefore, the first parameter can be directly determined as a lane detection parameter, and a lane detection result based on the lane detection parameter is output.

In some embodiments, if p1<p and p2>p, it means that a reliability of the first parameter included in the lane line parameter is low, and a reliability of the second parameter included in the boundary line parameter is high. Therefore, a lane detection parameter can be determined based on the second parameter. Because the second parameter is the parameter corresponding to the boundary curve, based on a relationship between the boundary curve and the lane curve of the lane, a curve obtained by offsetting the boundary curve inward a certain distance is the lane curve. Therefore, after the second parameter is determined, an inward offset parameter can be determined, so that a lane detection result can be determined according to the second parameter and the inward offset parameter, where the inward offset parameter can be denoted by d.

In some embodiments, if p1>p and p2>p, it means that reliabilities of the first parameter included in the lane line parameter and the second parameter included in the boundary line parameter are both high, and data fusion is performed on the first parameter and the second parameter according to a preset data fusion rule.

Based on a parallel relationship between the lane boundary curve and the lane curve, if the first parameter of the lane curve determined based on the visual detection data obtained by the vision sensor, and the second parameter of the boundary curve determined based on the radar detection data obtained by the radar sensor are completely correct, following relationships should be maintained: a₁=a₂, b₁=b₂, and c₁=c₂−d. In some embodiments, d is the inward offset parameter. Before the data fusion is performed on the first parameter (including a₁, b₁, c₁) and the second parameter (including a₂, b₂, c₂), a parallelism of the lane line curve and the boundary curve can be determined first to determine a parallel deviation value of the two curves:

$${Δ}_{1} = \frac{\vert {a}_{1} - {a}_{2} \vert}{\vert {a}_{1} + {a}_{2} \vert} + \frac{\vert {b}_{1} - {b}_{2} \vert}{\vert {b}_{1} + {b}_{2} \vert} \qquad Formula 2.1$$

After the parallel deviation value is determined, the parallel deviation value can be compared with a preset parallel deviation threshold ε₁, and based on a comparison result, the data fusion is performed on the first parameter and the second parameter to obtain the lane detection parameter.

In some embodiments, after the movable platform obtains the lane detection parameter, a corresponding target lane curve can be generated based on the lane detection parameter, and the target lane curve is output.

In the embodiments of the present disclosure, the movable platform can call the vision sensor disposed at the movable platform to perform lane detection to obtain visual detection data, and perform lane line analysis and processing based on the visual detection data, thereby obtaining the lane line parameters including the first parameter of the lane line curve and the corresponding first reliability, and further, the movable plate can call the radar sensor to perform lane detection to obtain the radar detection data, and perform the boundary analysis and processing based on the radar detection data, thereby obtaining the boundary line parameters including the second parameter of the boundary curve and the corresponding second reliability, so that the movable platform can perform data fusion based on the lane line parameters and the boundary line parameters to obtain lane detection parameters, and generate corresponding lane lines based on the lane detection parameters, which can effectively meet the lane detection needs in some special scenarios. An order of calling the vision sensor and calling the radar sensor by the movable platform is not limited. The aforementioned processes of S201 and S202 can be performed sequentially, simultaneously, or in a reverse order.

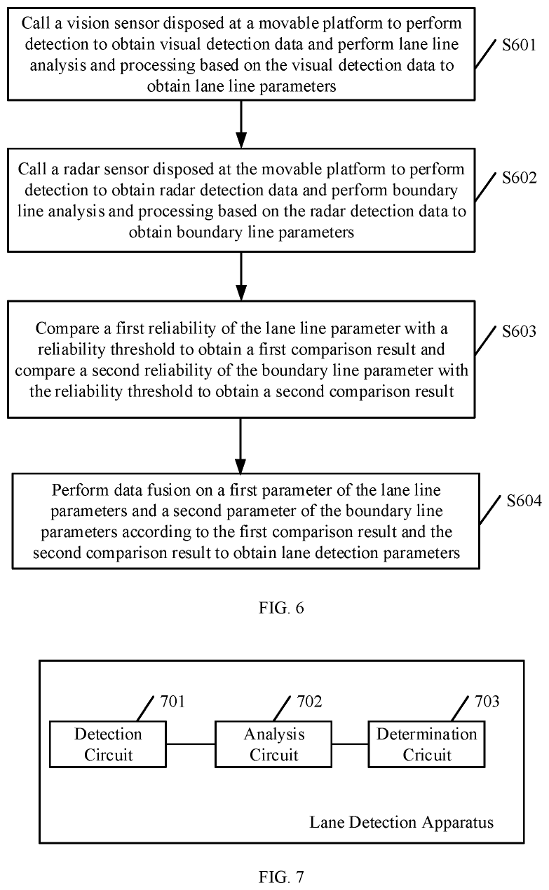

In some embodiments, in order to describe the embodiments of performing data fusion on the lane line parameters and the boundary line parameters to obtain the lane detection parameters, a schematic flowchart of a lane detection method is provided as shown in FIG. 6 according to an embodiment of the disclosure. The lane detection method can also be executed by a movable platform, in some embodiments, by a processor of the movable platform. The movable platform includes an unmanned vehicle. As shown in FIG. 6, at S601, a vision sensor disposed at the movable platform is called to perform detection to obtain visual detection data, and lane line analysis and processing are performed based on the visual detection data to obtain lane line parameters.

In some embodiments, when the movable platform calls the vision sensor to perform lane detection and obtain the visual detection data, the vision sensor can be called to collect an initial image first, and determine a target image area for lane detection from the initial image. The initial image collected by the vision sensor includes the above-described video frame image, and the target image area includes the above-described lower rectangular area of the video frame image.

After the target image area is determined, the movable platform can convert the target image area into a grayscale image, and can determine visual detection data based on the grayscale image. In some embodiments, after converting the target image to the grayscale image, the movable platform can perform a binarization operation on the grayscale image to obtain a discrete image corresponding to the grayscale image, denoise the discrete image, and use discrete points corresponding to lane lines in the denoised image as the visual detection data.

In some other embodiments, when the movable platform calls the vision sensor to perform lane detection and obtains the visual detection data, the vision sensor disposed at the movable platform may be called to collect an initial image first, so that a preset image recognition model can be used to recognize the initial image. The preset image recognition model may be, for example, a convolutional neural network (CNN) model. When the preset image recognition model is used to recognize the initial image, a probability that each pixel in the initial image belongs to the image area corresponding to the lane line may be determined, so that the probability corresponding to each pixel can be compared with a preset probability threshold, and the pixel with a probability greater than or equal to the probability threshold is determined as a pixel belonging to the lane line. That is, an image area to which the lane line belongs can be determined from the initial image based on the preset image recognition model. Further, visual detection data of the lane line can be determined according to a recognition result of the initial image.

After the movable platform determines the visual detection data, in order to obtain the lane line parameters based on the visual detection data, a lane line may be determined based on the visual detection data first, then the lane line may be analyzed and processed based on the visual detection data to obtain a first parameter of a lane line curve, and after a first reliability of the lane line curve is determined, the first parameter of the lane line curve and the first reliability are determined as the lane line parameters.

At S602, a radar sensor disposed at the movable platform is called to perform detection to obtain radar detection data, and boundary line analysis and processing are performed based on the radar detection data to obtain boundary line parameters.

In some embodiments, the movable platform may first call the radar sensor to collect an original target point group, and perform a clustering calculation on the original target point group to filter out an effective boundary point group. The filtered effective boundary point group is used to determine a boundary line, so that the effective boundary point group can be used as radar detection data.

After the movable platform determines the radar detection data, in order to further determine the boundary line parameters based on the radar detection data, the movable platform may first perform boundary line analysis and processing based on the radar detection data to obtain a second parameter of boundary line curve, and after a second reliability of the boundary line curve is determined, determine the second parameter of the boundary line curve and the second reliability as the boundary line parameters.

At S603, the first reliability of the lane line parameter is compared with a reliability threshold to obtain a first comparison result, and the second reliability of the boundary line parameter is compared with the reliability threshold to obtain a second comparison result.

At S604, data fusion is performed on the first parameter of the lane line parameters and the second parameter of the boundary line parameters according to the first comparison result and the second comparison result to obtain lane detection parameters.

The processes of S603 and S604 are specific refinements of process S203 in the above-described embodiments. If the first comparison result indicates that the first reliability is greater than the reliability threshold, and the second comparison result indicates the second reliability is greater than the reliability threshold, and if p1 is used to denote the first reliability, p2 is used to denote the second reliability, and p is used to denote the reliability threshold, that is, when p1>p, and p2>p, it means the reliabilities of the boundary line curve and the lane line curve obtained by fitting are relatively high, and it also means the reliabilities of the first parameter of the lane line curve and the second parameter of the boundary line curve are relatively high. The data fusion is performed based on the first parameter of the lane line parameters and the second parameter of the boundary line parameters to obtain lane detection parameters.

In some embodiments, based on Formula 2.1, a parallel deviation value Δ₁ of the lane line curve and the boundary line curve can be determined, and the parallel deviation value Δ₁ is compared with a preset parallel deviation threshold ε₁. If Δ₁<ε₁, based on the first reliability p1 and the second reliability p2, the first parameter (including a₁, b₁, c₁) and the second parameter (including a₂, b₂, c₂) are fused into a lane detection parameter. In some embodiments, the movable platform may, according to the first reliability p1 and the second reliability p2, search for a first weight value for the first parameter when fused into the lane detection parameter, and for a second weight value for the second parameter when fused into the lane detection parameter.

The first weight value includes sub weight values α₁, β₁, and θ₁, and the second weight value includes sub weight values α₂, β₂, and θ₂. The movable platform establishes in advance Table 1 for querying α₁ and α₂ based on the first reliability p1 and the second reliability p2, Table 2 for querying β₁ and β₂ based on the first reliability p1 and the second reliability p2, and Table 3 for querying θ₁ and θ₂ based on the first reliability p1 and the second reliability p2, so that the movable platform can query Table 1 based on the first reliability p1 and the second reliability p2 to determine α₁ and α, query Table 2 based on the first reliability p1 and the second reliability p2 to determine β₁ and β₂, and query Table 3 based on the first reliability p1 and the second reliability to determine θ₁ and θ₂.

If g1, g2, and g3 are used to denote Table 1, Table 2, and Table 3 respectively, there are:

α₁=g1(p1,p2);

β₁=g2(p1,p2);

θ₁=g3(p1,p2);

and correspondingly α₂=1−α₁, (β₂=1−β₁, θ₂=1−θ₁.

After the first weight values α₁, β₁, and θ₁, the first parameters a₁, b₁, and c₁, the second weight values α₂, β₂, and θ₂, and the second parameters a₂, b₂, and c₂ are determined, the data fusion can be performed based on the above parameters to obtain lane detection parameters. For example, It is assumed that the lane detection parameters include a₃, b₃, and c₃, when the data fusion is performed, the following equations are set:

a₃=α₁*a₁+α₂*a₂;

b₃=β₁*b₁+β₂*b₂;

c₃=θ₁*c₁+θ₂*(c₂−d).

Therefore, the data fusion of a₁, b₁, and c₁ with a₂, b₂, and c₂ can be performed to obtain lane detection parameters including a₃, b₃, and c₃. d is the inward offset parameter mentioned above, and a value of d is generally 30 cm.

In some embodiments, the larger the weight value, the higher the reliability of the corresponding sensor. The weight values in Table 1, Table 2 and Table 3 are preset based on the known reliability data, and d may be a preset fixed value, or may also be dynamically adjusted based on fitting results of the boundary line curve and the lane line curve determined based on the results of the two video frame images. In some embodiments, if the inward offset parameters determined based on the boundary line curve and the lane line curve, which are obtained after lane detection based on the two video frame images, are different, the inward offset parameters d are adjusted.

In some embodiments, after determining the lane detection parameters, the movable platform may generate a target lane line based on the obtained lane detection parameters, and the target lane line may be represented by x_{final}=a₂y²+b₂y+c₃.

In some other embodiments, if the parallel deviation value Δ₁ is compared with the preset deviation threshold ε₁, it is determined that the parallel deviation value Δ₁ is greater than or equal to the preset deviation threshold ε₁. That is, when Δ₁≥ε₁, based on the first reliability p1 and the second reliability p2, the first parameters a₁, b₁, c₁ and the second parameters a₂, b₂, and c₂ can be respectively fused as a first lane detection parameter and a second lane detection parameter. The first lane detection parameter corresponds to a first environmental area, and the first environmental area refers to an area with a distance to the movable platform less than a preset distance threshold. The second lane detection parameter corresponds to a second environmental area, and the second environmental area refers to an area with a distance to the movable platform greater than or equal to the preset distance threshold.

When Δ₁≥ε₁, it indicates that a parallelism between the lane line curve and the boundary line curve is poor. Based on a feature that the vision sensor has a weaker detection capability at a long distance and a stronger detection capability at a short distance, the first lane detection parameter and the second lane detection parameter can be determined respectively at different distances according to the first parameter and the second parameter. When the movable platform determines the first lane detection parameter and the second lane detection parameter, the first lane detection parameter and the second lane detection parameter can be obtained respectively by querying based on the first reliability and the second reliability. A table used to query the first lane detection parameter and a table used to query the second lane detection parameter are different, and the preset distance threshold is a value used to distinguish a short-distance end and a long-distance end.

If, based on the first reliability p1 and the second reliability p2, the first lane detection parameters a₄, b₄, c₄ and the second lane detection parameters a₅, b₅, c₅ are obtained by fusing the first parameters a₁, b₁, c₁ and the second parameters a₂, b₂, and c₂ respectively, a target lane line can be determined based on the obtained first lane detection parameters and second lane detection parameters as follows.

$${x}_{f i n a 1} = \{ \begin{matrix}{a}_{4} {y}^{2} + {b}_{4} y + {c}_{4} , y \leq {y}_{1} \\ {a}_{5} {y}^{2} + {b}_{5} y + {c}_{5} , y > {y}_{1}\end{matrix} \qquad Formula 6.1$$

where, y₁ is a preset distance threshold, and the preset distance threshold y₁ may be, for example, 10 meters.

In some embodiment, if the first comparison result indicates that the first reliability is less than or equal to the reliability threshold, and the second comparison result indicates that the second reliability is greater than the reliability threshold, that is, when p1≤p and p2>p, it means that a reliability of the lane line curve obtained by analysis is relatively low, while a reliability of the boundary line curve is relatively high. That is, a reliability of the first parameter of the lane line curve is relatively low and a reliability of the second parameter of the boundary line curve is relatively high. Therefore, the lane detection parameter can be determined based on the second parameter of the boundary line curve.

When the movable platform determines the lane detection parameter based on the second parameter of the boundary line curve, the inward offset parameter d needs to be determined first, so that the lane detection parameter can be determined based on the inward offset parameter d and the second parameter. In some embodiments, the target lane line can be obtained by offsetting inwardly according to the inward offset parameter d based on the boundary line curve.

In some embodiments, if the first comparison result indicates that the first reliability is greater than the reliability threshold, and the second comparison result indicates that the second reliability is less than or equal to the reliability threshold, that is, when p1>p and p2≤p, it means that a reliability of the lane line curve obtained by analysis is relatively high, but a reliability of the boundary line curve is relatively low. That is, a reliability of the first parameter of the lane line curve is relatively high and a reliability of the second parameter of the boundary line curve is relatively low. Therefore, the first parameter of the lane line curve can be determined as the lane detection parameter. In some embodiments, the lane line curve obtained by the analysis of the movable platform is the target lane line.

In the embodiment of the present disclosure, the movable platform calls the vision sensor to perform lane detection to obtain the vision detection data and obtains the lane line parameters by analyzing and processing based on the vision detection data, and calls the radar sensor to perform detection to obtain the radar detection data and obtain the boundary line parameters by analyzing and processing the boundary line based on the radar detection data, so that the first reliability included in the lane line parameters is compared with the reliability threshold to obtain the first comparison result, and the second reliability included in the boundary line parameters is compared with the reliability threshold to obtain the second comparison result. Based on the first comparison result and the second comparison result, the lane detection parameters can be obtained by performing data fusion on the first parameter of the lane line parameter and the second parameter of the boundary line parameter, and then the target lane line can be output based on the lane detection parameters. The detection advantages of the vision sensor and the radar sensor during the lane detection are effectively combined, so that different data fusion methods are used to obtain the lane detection parameters under different conditions, so as to obtain a higher precision of the lane detection parameters and effectively meet the lane detection needs in some special scenarios.

The embodiments of the present disclosure provide a lane detection apparatus, and the lane detection apparatus is used to perform any one of the methods described above. FIG. 7 is a schematic block diagram of a lane detection apparatus according to an embodiment of the present disclosure. The lane detection apparatus of the embodiments can be disposed at a movable platform such as an unmanned vehicle. The lane detection apparatus includes a detection circuit 701, an analysis circuit 702, and a determination circuit 703.

The detection circuit 701 is configured to call a vision sensor disposed at the movable platform to perform detection to obtain visual detection data. The analysis circuit 702 is configured to perform a lane line analysis and processing based on the visual detection data to obtain lane line parameters. The detection circuit 701 is further configured to call a radar sensor disposed at the movable platform to perform detection to obtain radar detection data. The analysis circuit 702 is further configured to perform a boundary line analysis and processing based on the radar detection data to obtain boundary line parameters. The determination circuit 703 is configured to perform data fusion according to the lane line parameters and the boundary line parameters to obtain lane detection parameters.

In some embodiment, the detection circuit 701 is configured to call the vision sensor disposed at the movable platform to collect an initial image, determine a target image area for lane detection from the initial image, convert the target image area into a grayscale image, and determine the visual detection data based on the grayscale image.

In some embodiments, the detection circuit 701 is configured to call the vision sensor disposed at the movable platform to collect an initial image, use a preset image recognition model to recognize the initial image, and according to a recognition result of the initial image, determine the visual detection data of the lane line.

In some embodiments, the analysis circuit 702 is configured to determine a lane line based on the visual detection data, analyze and process the lane line based on the visual detection data to obtain a first parameter of a lane line curve, determine a first reliability of the lane line curve, and determine the first parameter of the lane line curve and the first reliability as lane line parameters.

In some embodiments, the analysis circuit 702 is configured to perform lane line analysis and processing on the visual detection data based on a quadratic curve detection algorithm to obtain the first parameter of the lane line curve.

In some embodiments, the detection circuit 701 is configured to call the radar sensor disposed at the movable platform to collect an original target point group, perform a clustering calculation on the original target point group to filter out an effective boundary point group, and use the effective boundary point group as the radar detection data, where the filtered effective boundary point group is used to determine a boundary line.

In some embodiments, the analysis circuit 702 is configured to perform the boundary line analysis and processing based on the radar detection data to obtain a second parameter of a boundary line curve, determine a second reliability of the boundary line curve, and determine the second parameter of the boundary line curve and the second reliability as boundary line parameters.

In some embodiments, the determination circuit 703 is configured to compare the first reliability included in the lane line parameters with a reliability threshold to obtain a first comparison result, and compare the second reliability in the boundary line parameters with the reliability threshold to obtain a second comparison result, and according to the first comparison result and the second comparison result, perform data fusion on the first parameter in the lane line parameters and the second parameter in the boundary line parameters to obtain lane detection parameters.

In some embodiments, the determination circuit 703 is configured to, if the first comparison result indicates that the first reliability is greater than the reliability threshold, and the second comparison result indicates that the second reliability is greater than the reliability threshold, based on the first parameter in the lane line parameters and the second parameter in the boundary line parameters, determine a parallel deviation value of the lane line curve and the boundary line curve, and according to the parallel deviation value, perform data fusion on the first parameter and the second parameter to obtain lane detection parameters.

In some embodiments, the determination circuit 703 is configured to compare the parallel deviation value with a preset deviation threshold, and if the parallel deviation value is less than the preset deviation threshold, based on the first reliability and the second reliability, fuse the first parameter and the second parameter into lane detection parameters.

In some embodiments, the determination circuit 703 is configured to search and obtain a first weight value for the first parameter when fused into the lane detection parameter and obtain a second weight value for the second parameter when fused into the lane detection parameter according to the first reliability and the second reliability, and perform data fusion based on the first weight value, the first parameter, the second weight value, and the second parameter to obtain lane detection parameters.

In some embodiments, the determination circuit 703 is configured to compare the parallel deviation value with the preset deviation threshold, and if the parallel deviation value is greater than or equal to the preset deviation threshold, based on the first reliability and the second reliability, fuse the first parameter and the second parameter respectively into a first lane detection parameter and a second lane detection parameter, where the first lane detection parameter corresponds to a first environmental area, and the first environmental area refers to an area with a distance to the movable platform less than a preset distance threshold. The second lane detection parameter corresponds to a second environmental area, and the second environmental area refers to an area with a distance to the movable platform greater than or equal to the preset distance threshold.

In some embodiments, the determination circuit 703 is configured to, if the first comparison result indicates that the first reliability is less than or equal to the reliability threshold, and the second comparison result indicates the second reliability is greater than the reliability threshold, determine the lane detection parameter according to the second parameter of the boundary line curve.

In some embodiments, the determination circuit 703 is configured to determine an inward offset parameter, and determine the lane detection parameter according to the inward offset parameter and the second parameter of the boundary line curve.

In some embodiments, the determination circuit 703 is configured to, if the first comparison result indicates that the first reliability is greater than the reliability threshold, and the second comparison result indicates the second reliability is less than or equal to the reliability threshold, determine the first parameter of the lane line curve as the lane detection parameter.

In the embodiments of the present disclosure, the detection circuit 701 can call the vision sensor disposed at the movable platform to perform lane detection to obtain visual detection data, the analysis circuit 702 performs lane line analysis and processing based on the visual detection data, thereby obtaining the lane line parameters including the first parameter of the lane line curve and the corresponding first reliability, and further, the detection circuit 701 can call the radar sensor to perform detection to obtain the radar detection data, and the analysis circuit 702 performs the boundary analysis and processing based on the radar detection data, thereby obtaining the boundary line parameters including the second parameter of the boundary line curve and the corresponding second reliability, so that the determination circuit 703 can perform data fusion based on the lane line parameters and the boundary line parameters to obtain lane detection parameters, and generate corresponding lane lines based on the lane detection parameters, which can effectively meet the lane detection needs in some special scenarios.

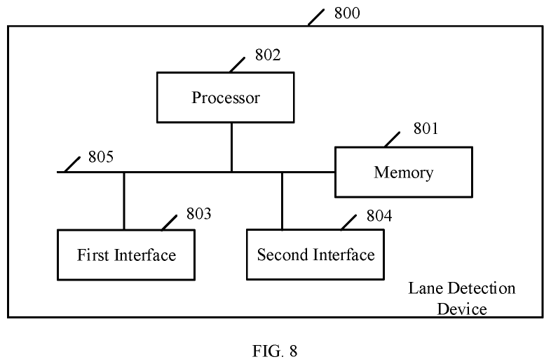

The embodiment of the present disclosure provides a lane detection device applied to a movable platform. FIG. 8 is a structural diagram of a lane detection device applied to a movable platform according to an embodiment of the present disclosure. As shown in FIG. 8, the lane detection device 800 applied to the movable platform includes a memory 801, a processor 802, and also includes structures such as a first interface 803, a second interface 804, and a bus 805. One end of the first interface 803 is connected to an external vision sensor, and the other end of the first interface 803 is connected to the processor. One end of the second interface 804 is connected to an external radar sensor, and the other end of the second interface 804 is connected to the processor.

The processor 802 may be a central processing unit (CPU). The processor 802 may be a hardware chip. The hardware chip may be an application-specific integrated circuit (ASIC), a programmable logic device (PLD) or a combination thereof. The PLD may be a complex programmable logic device (CPLD), a field-programmable gate array (FPGA), a general array logic (GAL), or any combination thereof.

A program code is stored at the memory 802, and the processor 802 calls the program code at the memory. When the program code is executed, the processor 802 is configured to call a vision sensor disposed at the movable platform through the first interface 803 to call a vision sensor disposed at the movable platform to perform detection to obtain visual detection data and perform a lane line analysis and processing based on the visual detection data to obtain lane line parameters, call a radar sensor disposed at the movable platform through the second interface 804 to perform detection to obtain radar detection data and perform a boundary line analysis and processing based on the radar detection data to obtain boundary line parameters, and perform data fusion according to the lane line parameters and the boundary line parameters to obtain lane detection parameters.

In some embodiment, when the processor 802 calls the vision sensor disposed at the movable platform to perform detection to obtain visual detection data, it is configured to call the vision sensor disposed at the movable platform to collect an initial image, determine a target image area for lane detection from the initial image, convert the target image area into a grayscale image, and determine the visual detection data based on the grayscale image.

In some embodiment, when the processor 802 calls the vision sensor disposed at the movable platform to perform detection to obtain visual detection data, it is configured to call the vision sensor disposed at the movable platform to collect an initial image, use a preset image recognition model to recognize the initial image, and according to a recognition result of the initial image, determine the visual detection data of the lane line.

In some embodiments, when the processor 802 performs the lane line analysis and processing based on the visual detection data to obtain lane line parameters, it is configured to determine a lane line based on the visual detection data, analyze and process the lane line based on the visual detection data to obtain a first parameter of a lane line curve, determine a first reliability of the lane line curve, and determine the first parameter of the lane line curve and the first reliability as lane line parameters.

In some embodiments, when the processor 802 analyzes and processes the lane line based on the visual detection data to obtain the first parameter of the lane line curve, it is configured to perform lane line analysis and processing on the visual detection data based on a quadratic curve detection algorithm to obtain the first parameter of the lane line curve.

In some embodiments, when the processor 802 calls the radar sensor disposed at the movable platform to perform detection to obtain radar detection data, it is configured to call the radar sensor disposed at the movable platform to collect an original target point group, perform a clustering calculation on the original target point group to filter out an effective boundary point group, and use the effective boundary point group as the radar detection data, where the filtered effective boundary point group is used to determine a boundary line.

In some embodiments, when the processor 802 performs the boundary line analysis and processing based on the radar detection data to obtain boundary line parameters, it is configured to perform the boundary line analysis and processing based on the radar detection data to obtain a second parameter of a boundary line curve, determine a second reliability of the boundary line curve, and determine the second parameter of the boundary line curve and the second reliability as boundary line parameters.

In some embodiments, when the processor 802 performs data fusion according to the lane line parameters and the boundary line parameters to obtain lane detection parameters, it is configured to compare the first reliability included in the lane line parameters with a reliability threshold to obtain a first comparison result, compare the second reliability in the boundary line parameters with the reliability threshold to obtain a second comparison result, and according to the first comparison result and the second comparison result, perform data fusion on the first parameter in the lane line parameters and the second parameter in the boundary line parameters to obtain lane detection parameters.

In some embodiments, when the processor 802 performs data fusion on the first parameter in the lane line parameters and the second parameter in the boundary line parameters to obtain lane detection parameters according to the first comparison result and the second comparison result, it is configured to, if the first comparison result indicates that the first reliability is greater than the reliability threshold, and the second comparison result indicates that the second reliability is greater than the reliability threshold, based on the first parameter in the lane line parameters and the second parameter in the boundary line parameters, determine a parallel deviation value of the lane line curve and the boundary line curve, and according to the parallel deviation value, perform data fusion on the first parameter and the second parameter to obtain lane detection parameters.

In some embodiments, when the processor 802 performs data fusion on the first parameter and the second parameter to obtain lane detection parameters according to the parallel deviation value, it is configured to compare the parallel deviation value with a preset deviation threshold, and if the parallel deviation value is less than the preset deviation threshold, based on the first reliability and the second reliability, fuse the first parameter and the second parameter into lane detection parameters.

In some embodiments, when the processor 802, based on the first reliability and the second reliability, fuses the first parameter and the second parameter into lane detection parameters, it is configured to search and obtain a first weight value for the first parameter when fused into the lane detection parameter and obtain a second weight value for the second parameter when fused into the lane detection parameter according to the first reliability and the second reliability, and perform data fusion based on the first weight value, the first parameter, the second weight value, and the second parameter to obtain lane detection parameters.

In some embodiments, when the processor 802 performs data fusion on the first parameter and the second parameter to obtain lane detection parameters according to the parallel deviation value, it is configured to compare the parallel deviation value with the preset deviation threshold, and if the parallel deviation value is greater than or equal to the preset deviation threshold, based on the first reliability and the second reliability, fuse the first parameter and the second parameter respectively into a first lane detection parameter and a second lane detection parameter, where the first lane detection parameter corresponds to a first environmental area, and the first environmental area refers to an area with a distance to the movable platform less than a preset distance threshold. The second lane detection parameter corresponds to a second environmental area, and the second environmental area refers to an area with a distance to the movable platform greater than or equal to the preset distance threshold.

In some embodiments, when the processor 802 performs data fusion on the first parameter in the lane line parameters and the second parameter in the boundary line parameters to obtain lane detection parameters according to the first comparison result and the second comparison result, it is configured to, if the first comparison result indicates that the first reliability is less than or equal to the reliability threshold, and the second comparison result indicates the second reliability is greater than the reliability threshold, determine the lane detection parameter according to the second parameter of the boundary line curve.

In some embodiments, when the processor 802 determines the lane detection parameter according to the second parameter of the boundary line curve, it is configured to determine an inward offset parameter, and determine the lane detection parameter according to the inward offset parameter and the second parameter of the boundary line curve.

In some embodiments, when the processor 802 performs data fusion on the first parameter in the lane line parameters and the second parameter in the boundary line parameters to obtain lane detection parameters according to the first comparison result and the second comparison result, it is configured to, if the first comparison result indicates that the first reliability is greater than the reliability threshold, and the second comparison result indicates the second reliability is less than or equal to the reliability threshold, determine the first parameter of the lane line curve as the lane detection parameter.

The lane detection device applied to the movable platform provided in the embodiments can execute the lane detection method as shown in FIGS. 2 and 6 provided in the foregoing embodiments, and the execution method and beneficial effects are similar, and will not be repeated here.

The embodiments of the present disclosure also provide a computer program product including instructions, which when run on a computer, causes the computer to execute relevant processes of the lane detection method described in the foregoing method embodiments.

A person of ordinary skill in the art can understand that all or part of the processes in the above-mentioned embodiment methods can be implemented by instructing relevant hardware through a computer program. The program can be stored in a computer readable storage medium. During the program is executed, it may include the processes of the above-mentioned method embodiments. The storage medium may be a magnetic disk, an optical disk, a read-only memory (ROM), or a random access memory (RAM), etc.

The above-described are only some of the embodiments of the present disclosure, which cannot be used to limit the scope of the present disclosure. Therefore, equivalent changes made according to the claims of the present invention still fall within the scope of the present invention.

What is claimed is:

1. A lane detection method comprising:
obtaining, via a vision sensor disposed at a movable platform, visual detection data;
performing lane line analysis and processing based on the visual detection data to obtain lane line parameters;
obtaining, via a radar sensor disposed at the movable platform, radar detection data;
performing boundary line analysis and processing based on the radar detection data to obtain boundary line parameters; and
performing data fusion according to the lane line parameters and the boundary line parameters to obtain lane detection parameters.

2. The method of claim 1, wherein obtaining the visual detection data includes:
collecting, via the vision sensor, an initial image;
determining a target image area for lane detection from the initial image;
converting the target image area into a grayscale image; and
determining the visual detection data based on the grayscale image.

3. The method of claim 1, wherein obtaining the visual detection data includes:
collecting, via the vision sensor, an initial image;
performing image recognition on the initial image using a preset image recognition model to obtain a recognition result; and
determining the visual detection data according to the recognition result.

4. The method of claim 1, wherein performing the lane line analysis and processing based on the visual detection data to obtain the lane line parameters includes:
determining a lane line based on the visual detection data;
analyzing and processing the lane line based on the visual detection data to obtain a fitting parameter of a lane line curve;
determining a reliability of the lane line curve; and
determining the fitting parameter and the reliability as the lane line parameters.

5. The method of claim 4, wherein analyzing and processing the lane line based on the visual detection data to obtain the fitting parameter includes:
performing lane line analysis and processing on the visual detection data based on a quadratic curve detection algorithm to obtain the fitting parameter.

6. The method of claim 1, wherein obtaining the radar detection data includes:
collecting, via the radar sensor, an original target point group; and
performing a clustering calculation on the original target point group to filter out an effective boundary point group, the effective boundary point group being used as the radar detection data and being used to determine a boundary line.

7. The method of claim 6, wherein performing the boundary line analysis and processing based on the radar detection data to obtain the boundary line parameters includes:
performing the boundary line analysis and processing based on the radar detection data to obtain fitting parameter of a boundary line curve;
determining a reliability of the boundary line curve; and
determining the fitting parameter and the reliability as the boundary line parameters.

8. The method of claim 1, wherein performing the data fusion according to the lane line parameters and the boundary line parameters to obtain the lane detection parameters includes:
comparing a first reliability included in the lane line parameters with a reliability threshold to obtain a first comparison result;
comparing a second reliability in the boundary line parameters with the reliability threshold to obtain a second comparison result; and
performing data fusion on a first fitting parameter of a lane line curve in the lane line parameters and a second fitting parameter of a boundary line curve in the boundary line parameters according to the first comparison result and the second comparison result to obtain the lane detection parameters.

9. The method of claim 8, wherein performing the data fusion on the first fitting parameter and the second fitting parameter according to the first comparison result and the second comparison result to obtain the lane detection parameters includes:
in response to the first comparison result indicating that the first reliability is greater than a reliability threshold and the second comparison result indicating that the second reliability is greater than the reliability threshold, determining a parallel deviation value of the lane line curve and the boundary line curve based on the first fitting parameter and the second fitting parameter; and
performing the data fusion on the first fitting parameter and the second fitting parameter according to the parallel deviation value to obtain the lane detection parameters.

10. The method of claim 9, wherein performing the data fusion on the first fitting parameter and the second fitting parameter according to the parallel deviation value to obtain the lane detection parameters includes:
comparing the parallel deviation value with a preset deviation threshold; and
in response to the parallel deviation value being less than the preset deviation threshold, fusing the first fitting parameter and the second fitting parameter into the lane detection parameters based on the first reliability and the second reliability.

11. The method of claim 10, wherein fusing the first fitting parameter and the second fitting parameter into the lane detection parameters based on the first reliability and the second reliability includes:
searching to obtain a first weight value for the first fitting parameter and a second weight value for the second fitting parameter according to the first reliability and the second reliability; and
performing the data fusion based on the first weight value, the first fitting parameter, the second weight value, and the second fitting parameter to obtain the lane detection parameters.

12. The method of claim 9, wherein performing the data fusion on the first fitting parameter and the second fitting parameter to obtain the lane detection parameters according to the parallel deviation value includes:
comparing the parallel deviation value with a preset deviation threshold; and
in response to the parallel deviation value being greater than or equal to the preset deviation threshold, fusing the first fitting parameter and the second fitting parameter respectively into a first lane detection parameter and a second lane detection parameter based on the first reliability and the second reliability, wherein:
the first lane detection parameter corresponds to a first environmental area with a distance to the movable platform less than a preset distance threshold; and
the second lane detection parameter corresponds to a second environmental area with a distance to the movable platform greater than or equal to the preset distance threshold.

13. The method of claim 8, wherein performing the data fusion on the first fitting parameter and the second fitting parameter to obtain the lane detection parameters according to the first comparison result and the second comparison result includes:
in response to the first comparison result indicating that the first reliability is less than or equal to a reliability threshold and the second comparison result indicating the second reliability is greater than the reliability threshold, determining the lane detection parameters according to the second fitting parameter.

14. The method of claim 13, wherein determining the lane detection parameters according to the second fitting parameter includes:
determining an inward offset parameter; and
determining the lane detection parameters according to the inward offset parameter and the second fitting parameter.

15. The method of claim 8, wherein performing the data fusion on the first fitting parameter and the second fitting parameter to obtain the lane detection parameters according to the first comparison result and the second comparison result includes:
in response to the first comparison result indicating that the first reliability is greater than a reliability threshold and the second comparison result indicating that the second reliability is less than or equal to the reliability threshold, determining the first fitting parameter o as the lane detection parameters.

16. A lane detection device comprising:
a first interface, one end of the first interface being configured to be connected to an vision sensor;
a second interface, one end of the second interface being configured to be connected to a radar sensor;
a processor connected to another end of the first interface and another end of the second interface; and
a memory storing a program code that, when executed by the processor, causes the processor to:
obtain, via the vision sensor, visual detection data;
perform lane line analysis and processing based on the visual detection data to obtain lane line parameters;
obtain, via the radar sensor, radar detection data;
perform boundary line analysis and processing based on the radar detection data to obtain boundary line parameters; and
perform data fusion according to the lane line parameters and the boundary line parameters to obtain lane detection parameters.

17. The device of claim 16, wherein the program code further causes the processor to:
collect, via the vision sensor, an initial image;
determine a target image area for lane detection from the initial image;
convert the target image area into a grayscale image; and
determine the visual detection data based on the grayscale image.

18. The device of claim 16, wherein the program code further causes the processor to:
collect, via the vision sensor, an initial image;
perform image recognition on the initial image using a preset image recognition model to obtain a recognition result; and
determine the visual detection data according to the recognition result.

19. The device of claim 16, wherein the program code further causes the processor to:
perform lane line analysis and processing on the visual detection data based on a quadratic curve detection algorithm to obtain a fitting parameter of a lane line curve.

20. The device of claim 16, wherein the program code further causes the processor to:
collect, via the radar sensor, an original target point group; and
perform a clustering calculation on the original target point group to filter out an effective boundary point group, the effective boundary point group being used as the radar detection data and being used to determine a boundary line.
